(19) United States
(12) Patent Application Publication
(10) Pub. No.: US 2018/0035294 A1
(43) Pub. Date: Feb. 1, 2018

(54) SERVICE DISCOVERY

(71) Applicant: Nokia Technologies Oy, Espoo (FI)

(72) Inventors: Jukka REUNAMÄKI, Tampere (FI); Arto PALIN, Akaa (FI); Teemu SAVOLAINEN, Nokia (FI); Niko KIUKKONEN, Espoo (FI)

(21) Appl. No.: 15/550,511

(22) PCT Filed: Feb. 16, 2015
(86) PCT No.: PCT/FI2015/050092

§ 371 Date: Aug. 11, 2017

(51) Int. Cl. H04W 12/06; H04W 12/08; H04W 4/00; G06F 21/62

(52) U.S. Cl. CPC H04W 12/06; G06F 21/62; H04W 12/08; H04W 4/001; H04L 9/32

(57) ABSTRACT

A technique for service discovery is provided. According to an example embodiment, the technique comprises creating in a wireless communication device and in dependence of a service authentication key associated with a service available in the wireless communication device, a concealed service identifier for identification of said service, constructing a service information message comprising a device identifier assigned for said wireless communication device and said concealed service identifier, and transmitting said service information message from the wireless communication device over a wireless link to one or more further wireless communication devices.

### TECHNICAL FIELD

The example and non-limiting embodiments of the present invention relate to service discovery and service provision in context of wireless communication.

### BACKGROUND

Service discovery in a wireless communication environment may be based on a device offering a certain service arranged to wirelessly broadcast service indications and/or service information for other devices in the operating range of the applied wireless communication technology.

In such a scenario the information pertaining to the certain service is receivable by all wireless devices that are capable of communication using the applied wireless technology. However, in many scenarios it may desirable or even crucial to keep the broadcasted service indications and/or service information hidden from devices other than one or more intended recipients of the service indications/information.

### SUMMARY

According to an example embodiment, an apparatus is provided, the apparatus comprising a wireless communication portion for wireless communication with other apparatuses and a control portion arranged to create, in dependence of a service authentication key associated with a service available in said apparatus, a concealed service identifier for identification of said service, to construct a service information message comprising a device identifier assigned for said apparatus and said concealed service identifier; and to transmit, using said wireless communication portion, said service information message over a wireless link to one or more further apparatuses.

According to another example embodiment, an apparatus is provided, the apparatus comprising a wireless communication portion for wireless communication with other apparatuses and a control portion arranged to receive, over a wireless link via said wireless communication portion, a service information message from a further apparatus, said message comprising a device identifier assigned for said further apparatus and a concealed service identifier for identification of a service available in said further apparatus, to determining whether a service authentication key matching the concealed service identifier received in said message is available in the apparatus, and to identify, in response to said determination being affirmative, the service available in said further apparatus as a service associated with the service authentication key found to match said concealed service identifier.

According to another example embodiment, an apparatus is provided, the apparatus comprising at least one processor and at least one memory including computer program code for one or more programs, the at least one memory and the computer program code configured to, with the at least one processor, cause the apparatus at least to create, in dependence of a service authentication key associated with a service available in the apparatus, a concealed service identifier for identification of said service, to construct a service information message comprising a device identifier assigned for the apparatus and said concealed service identifier, and to transmit said service information message from said apparatus over a wireless link to one or more further wireless communication devices.

According to another example embodiment, an apparatus is provided, the apparatus comprising at least one processor and at least one memory including computer program code for one or more programs, the at least one memory and the computer program code configured to, with the at least one processor, cause the apparatus at least to receive, over a wireless communication link, a service information message from a further apparatus, said message comprising a device identifier assigned for said further apparatus and a concealed service identifier for identification of a service available in said further apparatus, to determine whether a service authentication key matching the concealed service identifier received in said message is available in the apparatus and to identify, in response to said determination being affirmative, the service available in said further apparatus as a service associated with the service authentication key found to match said concealed service identifier.

According to another example embodiment, an apparatus is provided, the apparatus comprising means for creating, in dependence of a service authentication key associated with a service available in the apparatus, a concealed service identifier for identification of said service, means for constructing a service information message comprising a device identifier assigned for said apparatus and said concealed service identifier, and means for transmitting said service information message over a wireless link to one or more further apparatuses.

According to another example embodiment, an apparatus is provided, the apparatus comprising means for receiving a service information message from a further apparatus, said message comprising a device identifier assigned for said further apparatus and a concealed service identifier for identification of a service available in said further apparatus, means for determining whether a service authentication key matching the concealed service identifier received in said message is available in the apparatus, and means for identifying, in response to said determination being affirmative, the service available in said further apparatus as a service associated with the service authentication key found to match said concealed service identifier.

According to another example embodiment, a method is provided, the method comprising creating, in a wireless communication device and in dependence of a service authentication key associated with a service available in the wireless communication device, a concealed service identifier for identification of said service, constructing a service information message comprising a device identifier assigned for said wireless communication device and said concealed service identifier, and transmitting said service information message from the wireless communication device over a wireless link to one or more further wireless communication devices.

According to another example embodiment, a method is provided, the method comprising receiving, in a wireless communication device, a service information message from a further wireless communication device, said message comprising a device identifier assigned for said further wireless communication device and a concealed service identifier for identification of a service available in said further wireless communication device, determining whether a service authentication key matching the concealed service identifier received in said message is available in the wireless communication device and identifying, in response to said determination being affirmative, the service available in said further wireless communication device as a service associated with the service authentication key found to match said concealed service identifier.

According to another example embodiment, a computer program is provided, the computer program comprising computer readable program code configured to cause performing at least the following when said program code is executed on a computing apparatus: creating, in the computing apparatus in dependence of a service authentication key associated with a service available in the computing apparatus, a concealed service identifier for identification of said service, constructing a service information message comprising a device identifier assigned for a wireless communication apparatus in said computing apparatus and said concealed service identifier, and transmitting said service information message from the computing apparatus over a wireless link to one or more further apparatuses.

According to another example embodiment, a computer program is provided, the computer program comprising computer readable program code configured to cause performing at least the following when said program code is executed on a computing apparatus: receiving, in the computing apparatus via a wireless link, a service information message from a further apparatus, said message comprising a device identifier assigned for a wireless communication apparatus in said further apparatus and a concealed service identifier for identification of a service available in said further apparatus, determining whether a service authentication key matching the concealed service identifier received in said message is available in the computing apparatus and identifying, in response to said determination being affirmative, the service available in said further apparatus as a service associated with the service authentication key found to match said concealed service identifier.

The computer program according to an example embodiment may be embodied on a volatile or a non-volatile computer-readable record medium, for example as a computer program product comprising at least one computer readable non-transitory medium having program code stored thereon, the program which when executed by an apparatus cause the apparatus at least to perform the operations described hereinbefore for the computer program according to an example embodiment of the invention.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 schematically illustrates some components of a wireless communication arrangement together with some components of devices according to an example embodiment;

FIG. 2 illustrates a payload structure according to an example embodiment;

FIG. 3 illustrates a payload structure according to an example embodiment;

FIG. 4 illustrates a service information message according to an example embodiment;

FIG. 5 illustrates the advertising data and scan response data according to the Bluetooth Low Energy;

FIG. 6 illustrates mapping of a payload according to example embodiment to the Bluetooth Low Energy advertising data and scan response data;

FIG. 7 illustrates a method according to an example embodiment; and

FIG. 8 illustrates a method according to an example embodiment.

### DESCRIPTION OF SOME EMBODIMENTS

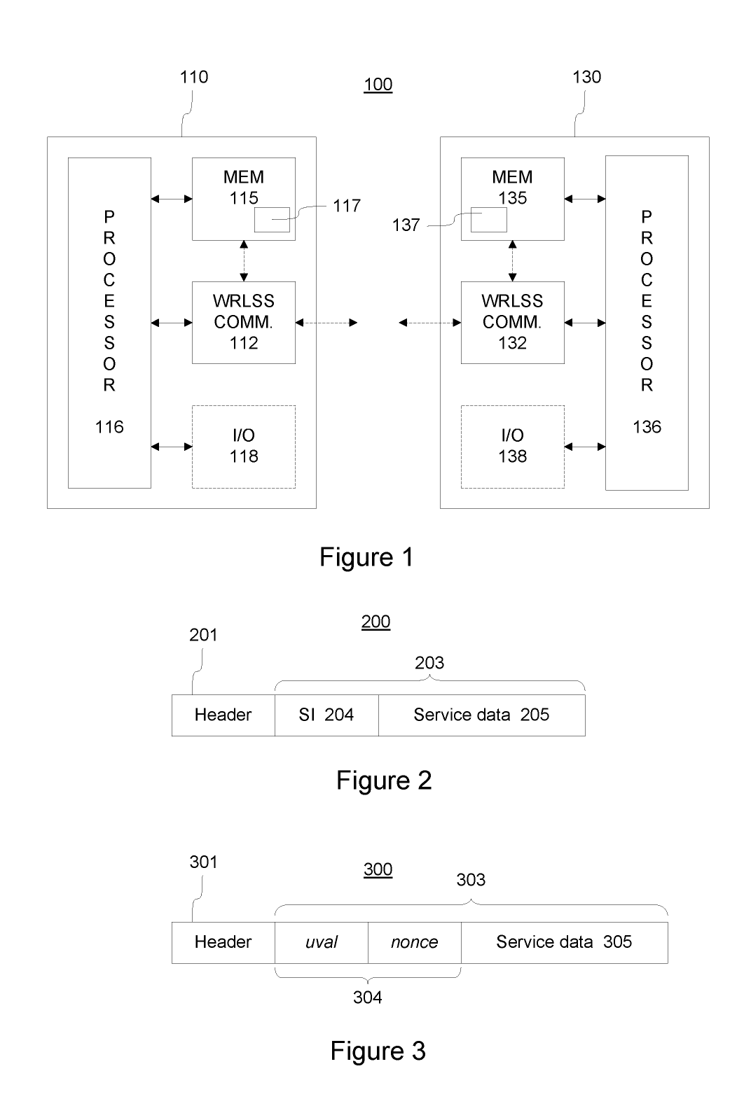

FIG. 1 schematically illustrates some components and/or entities of a wireless communication arrangement 100 to depict an exemplifying framework for one or more embodiments of the present invention. In the communication arrangement 100, a first device 110 and a second device 130 are arranged to communicate with each other over a wireless link in order to carry out a service discovery procedure, possibly followed by connection creation, connection establishment and information exchange between the two devices 110, 130 in order to provide said service, as will be described in more detail in the examples provided in the following.

The provision of the service may include, for example, providing information stored in one of the devices 110, 130 to the other one. The information may comprise pre-stored static information available in respective one of the devices 110, 130 or part thereof, or the information may comprise dynamically updated information e.g. received by respective one of the devices 110, 130 from a further device (e.g. via a wired communication channel) and/or extracted by using sensor means provided in respective one of the devices 110, 130. However, the exact characteristics of the service are not material to the embodiments of the present invention, as will become apparent on basis of the following description.

The components of the communication arrangement 100 depicted in FIG. 1 provide a non-limiting example that depicts a single first device 110 and a single second device 130 for improved clarity of illustration and for improved clarity and for brevity of description. However, in general there may be one or more first devices 110 and one or more second devices 130, where the service discovery procedure is carried out between a certain first device 110 and a certain second device 130. In the following, the term first device 110, when used in the singular form, is applied to jointly refer to any of the one or more first devices 110 unless explicitly stated otherwise. Similarly, the term second device 130, when used in the singular form, is applied to jointly refer to any of the one or more second devices 130 unless explicitly stated otherwise.

Each of the first device 110 and the second device 130 may be a mobile device or a stationary device. Herein, the term stationary device refers to a non-mobile device installed in its operating environment in a fixed manner. In a non-limiting example scenario, the first device 110 may be provided as a mobile user device such as a mobile phone, a smartphone, a music player, a media player, a tablet computer, a laptop computer, a portable navigation device, etc, whereas the second device 130 may be provided as a mobile or stationary device that forms part of the Internet of Things (IoT) or a sensor device arranged to measure and report one or more environmental parameters. Regardless of type of the devices 110, 130 (in terms of being mobile or stationary devices), they may be arranged to apply service discovery procedure and service information provision in accordance with non-limiting examples described in the following.

FIG. 1 further schematically illustrates some components of an exemplifying first device 110. The first device 110 may comprise further components or portions in addition to those depicted in FIG. 1, whereas the ones depicted therein are ones that are considered relevant for description of some embodiments of the present invention. The first device 110 comprises a wireless communication portion 112 for wireless communication with other devices. The wireless communication portion 112 comprises one or more wireless communication apparatuses. A wireless communication apparatus of the wireless communication portion 112 may be also considered as a wireless communication means. A wireless communication apparatus of the wireless communication portion 112 may enable, for example, wireless communication with other devices using a wireless communication technique or protocol that enables a point-to-point or a point-to-multipoint wireless connection with another device. The first device 110 is hence capable of communicating with other devices that are equipped with a communication apparatus using the same technique/protocol, e.g. with the second device 130.

The first device 110 further comprises a processor 116 and a memory 115 for storing data and computer program code 117. The first device 110 may further comprise user I/O (input/output) components 118 that may be arranged, possibly together with the processor 116 and a portion of the computer program code 117, to provide a user interface for receiving input from a user of the first device 110 and/or providing output to the user of the first device 110. The processor 116 may be arranged to control operation of the first device 110 e.g. in accordance with the computer program code 117 stored in the memory 115 and possibly further in accordance with the user input received via the user I/O components 118 and/or in accordance with information received via the wireless communication portion 112. The memory 115 and a portion of the computer program code 117 stored therein may be further arranged to, with the processor 116, to provide a control function for controlling operation of a wireless communication apparatus of the wireless communication portion 112, possibly together with a control portion or a control function that may be provided within the respective wireless communication apparatus (which will be described later in this text). These control functions may be, separately or jointly, referred to as control means (of the first device 110).

FIG. 1 further schematically illustrates some components of an exemplifying second device 130. The second device 130 may comprise further components or portions in addition to those depicted in FIG. 1, whereas the ones depicted therein are ones that are considered relevant for description of some embodiments of the present invention. The second device 130 comprises a wireless communication portion 132, which may be similar to the wireless communication portion 112. Hence, a wireless communication apparatus of the wireless communication portion 132 may, for example, enable wireless communication with the first device 110 and/or with other devices equipped with communication means using the same technique/protocol.

The second device 130 further comprises a processor 136 and a memory 135 for storing data and computer program code 137. The second device 130 may further comprise user I/O (input/output) components 138 that may be arranged, together with the processor 136 and a portion of the computer program code 137, to provide a user interface for receiving input from a user of the second device 130 and/or providing output to the user of the second device 130. The processor 136 may be arranged to control operation of the second device 130 in accordance with the computer program code 137 stored in the memory 135 and possibly further in accordance with the user input received via the user I/O components 138 and/or in accordance with information received via the wireless communication portion 132. The memory 135 and a portion of the computer program code 137 stored therein may be further arranged, with the processor 136, to provide a control function for controlling operation of a wireless communication apparatus of the wireless communication portion 132, possibly together with a control portion of a control function that may be provided within the respective wireless communication apparatus (which will be described later in this text). These control functions may be, separately or jointly, referred to as control means (of the second device 130). The second device 130 may comprise further components or portions in addition to those depicted in FIG. 1.

As described in the foregoing, each of the wireless communication portions 112, 132 comprises one or more respective wireless communication apparatuses, where a wireless communication apparatus may be also referred to as wireless communication means. A wireless communication apparatus may be provided e.g. as a respective chipset and/or as a respective communication module. For clarity and brevity of description, each wireless communication apparatus comprised in the wireless communication portion 112, 132 may be considered as a single logical entity that may also be capable of processing at least some of the information received via the wireless link and/or at least some of the information that is to be transmitted via the wireless link without external control from other components of the respective device 110, 130 (e.g. from the processor 116, 136, respectively). In an embodiment, a wireless communication apparatus of the wireless communication portion 112, 132 comprises e.g. a wireless transceiver portion for wireless communication and a control portion (or a control function) for controlling operation of the respective wireless transceiver portion and for processing information received/transmitted via the respective wireless transceiver portion. Such a control function may be provided by hardware means, by software means or by a combination of hardware means and software means. As an example in this regard, the wireless communication apparatus may comprise a memory, a processor and a computer program code stored in the memory may be arranged to, with the processor, provide the control function for controlling operation of the respective wireless communication apparatus either independently or jointly with the control function provided by the memory 115, 135, the computer program 117, 137 and the processor 116, 136 of the respective device 110, 130.

The wireless link between a wireless communication apparatus of the wireless communication portion 112 and a respective wireless communication apparatus of the wireless communication portion 132 may be provided by employing a suitable short-range wireless communication technique or protocol. The term short-range wireless communication as used herein refers to a wireless communication technique or protocol that enables typical operating range in the scale of tens of meters, e.g. up to 100 meters. However, especially in an indoor environment, the operating range of such short-range wireless communication technique/protocol may be significantly shorter e.g. due to walls and other stationary structures as well as furniture etc. that are likely to partially block or interfere with the radio communication between wireless communication portions. On the other hand, in favorable conditions in outdoor use the operating range may extend to several hundreds of meters.

An example of such a wireless technique/protocol is the Bluetooth Low Energy (BLE) protocol, specified e.g. in the Bluetooth Specification Version 4.1, Covered Core Package version 4.1 (publication date 3 Dec. 2013), incorporated herein by reference in its entirety. In the following, this document is referred to as a Bluetooth Specification. Another example is the Wireless Local Area Network (WLAN) technology, specified e.g. in IEEE 802.11 specifications, where the acronym IEEE stands for the Institute of Electrical and Electronics Engineers. However, the BLE and WLAN technologies serve as illustrative and non-limiting examples in this regard, and the description generalizes into any wireless communication technique/protocol that makes use of service discovery and service provision of similar kind.

In the following, this text may simply refer to a device 110, 130 carrying out a certain operation (e.g. receiving and/or transmitting certain message(s)) when describing the act of a wireless communication apparatus of the respective wireless communication portion 112, 132 carrying out said certain operation under control of the respective control function or control means. This approach is believed to improve editorial clarity and readability of the text, while the technical meaning of such expressions remains clear.

The first device 110 and the second device 130 may, when within an operating range from each other, carry out a device discovery procedure that may involve the second device 130 transmitting (e.g. broadcasting), over a wireless link, messages related to the connection creation and connection establishment with the second device 130 and/or information related to the identity of the second device 130, and the first device 110 possibly responding to such messages by requesting further information from and/or connection to be created/established with the second device 130.

Along similar lines, the first device 110 and the second device 130, when within an operating range from each other, may carry out a service discovery procedure that may involve the second device 130 transmitting (e.g. broadcasting), over a wireless link, messages that identify one or more services available thereat and/or carry information pertaining to said one or more services, and the first device 110 possibly responding by requesting further service information from and/or connection to be created/established with the second device 130. The information identifying one or more services available at the second device 130 may comprise one or more service identifiers, each serving as an identification of a respective service. In order to enable the first device 110 to recognize the available service(s) on basis of the service identifier(s), the same (predefined) mapping between service identifier value(s) and corresponding services is applied in the first device 110 and in the second device 130.

The device discovery and service discovery procedures may be carried out jointly, such that the second device 130 jointly transmits (e.g. broadcasts) both information that indicates its presence and identity to other devices and information that identifies one or more services available in the second device 130. Consequently, upon receiving this information, the first device 110 may respond by requesting further service information and/or connection to be created with the second device 130.

The device discovery may be followed by a pairing procedure between the devices involved, e.g. between the first device 110 and the second device 130. The pairing procedure facilitates connection establishment between the devices 110, 130 in a secure manner. In the pairing procedure, the first device 110 and the second device 130 create, in the course of a device selection procedure and a connection establishment procedure between the devices 110, 130, a shared secret key, which may also be referred to as an authentication key or as a device authentication key. The pairing procedure may be followed by bonding, which involves storing the device authentication key in the two devices 110, 130 to be used for authentication in subsequent connection establishment procedures between the devices 110, 130. Consequently, upon a subsequent connection request one of the devices 100, 130 may apply the device authentication key to authenticate the other one of the devices 110, 130 and hence the connection may be established in a secure manner without need for user action. Moreover, the device authentication key may be applied to encrypt and/or decrypt information transferred between the devices 110, 130. Hence, the pairing and bonding procedures contribute towards automated but yet secure connection establishment between the devices 110, 130.

The one or more service identifiers applied to identify the respective service(s) available at the second device 130 (operating as the discoverable device) may be receivable by any other device within the operating range, and hence the availability of the respective one or more services is advertised to any other device within the operating range. As described in the foregoing, the one or more service identifiers may be carried in one or more messages transmitted (e.g. broadcast) from the second device 130. Each message involved in carrying the service identifiers may include one or more of the service identifier(s). Consequently, upon reception of the message(s) carrying an service identifier of interest, the first device 110 may respond by transmitting one or more response messages addressed to the second device 130 in order to request (further) service information pertaining to the service of interest from the second device 130.

FIG. 2 schematically illustrates a conceptual example of a structure of a payload 200 that may be used to carry one or more service identifiers (SIs). The payload 200 may also be referred to as a packet 200. In this example the payload 200 includes a payload header 201 and payload data 203. The payload header 201 may carry information that indicates the structure and/or content of the payload data 203, possibly together with further control information. In this example, the payload data 203 comprises a single service identifier 204 and service data 205 associated with the service identified by the service identifier 204. The service data 205 may include service information pertaining to the service identified by the service identifier 204. In other examples, the payload data 203 may comprise multiple (e.g. two or more) service identifiers and/or the service data 205 may be omitted from the payload 200. In case of multiple service identifiers 204 the service data 205 part may carry information that is associated with the service identified by one of the service identifiers 204 or the service data part 205 may include a respective dedicated data portion for the services identified by two or more service identifiers 203. In such a scenario the mapping between the content of the service data 205 part and the service identifiers 203 may be provided in the payload header 201.

However, for some services and/or for some second devices 130 it may be desirable to hide the availability of the services offered by the second device 130 such that only certain other devices are able to identify the availability of the respective service at the second device 130. For such a scenario, a service identifier in one or more messages transmitted from the second device 130 may be provided as a concealed service identifier (CSI). As an example, a combination of ‘public’ service identifier and a concealed service identifier may be applied to provide different level of access to the same information such that the concealed service identifier (that is recognizable only by a restricted set of devices) provides full access to the service information, whereas the ‘public’ service identifier (that is available for all devices) enables access to a limited set of the service information. As a variation of this example, a first concealed service identifier may provide full access to the service information while a second concealed service identifier provides access to a limited set of the service information.

The concealed service identifier is created in dependence of a predefined secret component that is associated with the respective service and that is shared between the device 130 and other devices (e.g. the first device 110) that are intended recipients of the service identified by the concealed service identifier. In other words, only the devices that have the predefined secret component associated with the respective service in their disposal are able to identify the service indicated by the concealed service identifier. Herein, the shared secret component employed in creating and identifying the service associated with the concealed service identifier is referred to as a service authentication key.

As an example, the concealed service identifier may be comprise a unique identifier uval computed using a predefined hash function with a predefined service-specific service authentication key and a random or pseudo-random component as its arguments. As a non-limiting example, such service authentication key provided for computation (and/or resolving) of the service identifier may be referred to in the following as a service resolving key (SRK) associated with a service. There may be also one or more further service authentication keys associated with the same service, as will be described in more detail later in this text.

For a given service, the unique identifier uval may be computed e.g. as

uval=hashₛ(SRK,nonce),

where hashₛ( ) indicates the predefined hash function, where the parameter SRK represents the SRK associated with the given service, and where the parameter nonce represents the random or pseudo-random component. The concealed service identifier may be provided as a combination of two data fields (or data portions), first of which carries the unique identifier uval and second of which carries the random or pseudo-random component nonce applied in computing the unique identifier uval.

The predefined hash function hashₛ( ) may be any hash function known in the art considered to provide desired level of collision resistance and hence a desired level of security. While it is possible for the second device 130 to apply a randomly or pseudo-randomly selected static value for the parameter nonce, the value of the parameter nonce is preferably changed periodically (e.g. according to a predefined procedure or rule) for improved security and to make it more difficult for any unintended recipients of a message carrying the concealed service identifier 304 to track the identity of the service identified by the concealed service identifier 304 and/or the identity of the second device 130 on basis of the value of the parameter nonce.

FIG. 3 schematically illustrates a conceptual example of a structure of a payload 300 that may be used to carry one or more concealed service identifiers. The payload 300 may also be referred to as a packet 300. In this example the payload 300 includes a payload header 301 and payload data 303. As in case of the example of FIG. 2, the payload header 301 may carry information that indicates the structure and/or content of the payload data 303, possibly together with further control information. In this example, the payload data 303 comprises a single concealed service identifier 304 and service data 305 associated with the service identified by the concealed service identifier 304. The concealed service identifier 304 is provided as a combination of a first portion that carries the value of the uval and a second portion that carries the value of the nonce. The service data 305 may include service information pertaining to the service identified by the concealed service identifier 304. Alternatively or additionally, the service data 305 may include information that enables establishing paring and bonding with the second device 130.

In other examples, one of the concealed service identifier 304 and the service data 305 may be omitted from the payload 300. In such a case one payload 300 may carry the concealed service identifier 304 (with the service data 305 omitted from the payload 300) and a subsequent payload 300 may carry the service data 305 (with the concealed service identifier 304 omitted from the payload 300). As a further option, the service data 305 may be omitted altogether (e.g. not transmitted in the same payload with the concealed service identifier 304 or in a separate payload). In a further example the data part 303 may comprise multiple (e.g. two or more) concealed service identifiers. In case of multiple concealed service identifiers 304 the service data 305 (if included in the payload 300) may carry information that is associated with the service identified by one of the concealed service identifiers 304 or the service data part 305 may include a respective dedicated data portion for respective services identified by the two or more concealed service identifiers 304. In such a scenario the mapping between the content of the service data 305 part and the concealed service identifiers 304 may be provided in the payload header 301.

In a further example, the value of the parameter nonce may be excluded from the concealed service identifier 304. In such an approach the value of the nonce may be a pseudo-random value that is derivable e.g. by a predefined pseudo-random procedure that is associated with the SRK applied in computing the value of the uval, thereby enabling the devices that have access to the SRK associated with the service identified by the value of the uval to identify or recognize the service identified by the concealed service identifier 304 (also) without receiving the value of the nonce in the payload 300.

The service data 305 (when included in the payload 300) or part thereof may be encrypted by the second device 130 to avoid devices other than the intended recipient(s) of the payload 300 having access to the information carried in the service data 305. In this regard, the second device 130 may apply encryption means (e.g. an encryption function or routine provided by software means) provided therein to carry out the encryption by using the SRK associated with the service identified by the concealed service identifier 304 to generate encrypted service information on basis of service information to be transmitted in the service data 305. The service authentication key used for encryption may be the SRK applied in creating the respective concealed service identifier 304. As another example, another predefined service authentication key associated with the service identified by the concealed service identifier 304 may be used for encryption. As a non-limiting example in this regard, in addition to the SRK, there may be a service data resolving key (SDRK) associated with a service, and the service data 305 for the respective service may be encrypted using the SDRK associated therewith.

The encryption means applied in the second device 130 may be initialized with one or more initialization values prior to encrypting the service data 305. As an example in this regard, the unique identifier uval (or a predefined portion thereof) and/or the random or pseudo-random value nonce (or a predefined portion thereof) may be applied as initialization value(s) for the encryption means. Consequently, even in a scenario where the service information remains unchanged (or constant) over a period of time, the respective encrypted service data 305 changes from payload 300 to another with the changing initialization values, thereby contributing towards improved security and increased difficulty for any unintended recipients of the payload 300 tracking the identity of the second device 130 on basis of the service data 305.

In order to enable recognizing a service identified by a concealed service identifier received in a message from the second device 130, the first device 110 needs to have access to the same predefined hash function applied in the second device and it needs to know the SRK associated with the service identified by the concealed service identifier 304. In this regard, the first device 110 may store (e.g. in the memory 115 and/or in a mass storage device accessible by the first device 110) the hash function hashₛ( ) and a set of one or more service authentication keys for one or more services, where for each service the one or more service authentication keys include at least the SRK associated with a respective service. Consequently, upon reception of the concealed service identifier 304, the first device 110 may determine whether a SRK matching the one received from the second device 130 (and hence indicating the respective service) is available in the first device 110.

The determination may involve the first device 110 testing the SRKs available therein one by one either until a matching SRK is encountered or until all available SRKs have been tested without encountering a matching SRK. Alternatively, the determination may involve the first device 110 transmitting one or more SRKs available in the first device 110 and the concealed service identifier 304 received from the second device 130 to a further device (e.g. a server device), which carries out the testing and provides the first device 110 with an indication of a matching SRK having been encountered or an indication that no matching SRK was encountered.

In case the concealed service identifier 304 comprises the data fields that carry the unique identifier uval and the random or pseudo-random component nonce, the testing may involve computing the local unique identifier by

local_uvalᵢ=hashₛ(SRKᵢ,nonce),

where hashₛ( ) indicates the same predefined hash function applied in the second device 130 for computing the uval received as part of the concealed service identifier 304, where the parameter SRK indicates the SRK under consideration, and where the parameter nonce represents the random or pseudo-random component received as part of the concealed service identifier 304. Alternatively, as described in the foregoing, the value of the nonce may not be received in the concealed service identifier 304 (which may hence include only the parameter uval) but it may be a pseudo-random value that is derivable e.g. by a predefined pseudo-random procedure that is associated with the SRKᵢ (and that may be stored in the first device 110 together with SRKᵢ)

The SRKᵢ is considered as a matching SRK in case the local_uvalᵢ is equal to the uval received as part of the concealed service identifier. If a matching service authentication key SRKᵢ is found, the first device 110 identifies the service associated therewith as the service indicated by the concealed service identifier 304.

While encountering the matching service authentication key SRKᵢ in the first device 110 serves as an identification of the service indicated by the concealed service identifier 304, the matching service authentication key SRKᵢ may be subsequently applied also for encrypting messages or data prior to transmission to the second device 130 and/or for decrypting data received from the second device 130. As an example in this regard, as described in the foregoing, the service data 305 possibly included in the payload 300 may be encrypted by the second device 130 using the SRK associated with the service identified by the concealed service identifier 304. In this regard, the first device 110 may apply decryption means (e.g. a decryption function or routine provided by software means) provided therein to carry out the decryption by using the matching service authentication key SRKᵢ to decrypt the service data 305 received in the payload 300.

Alternatively, as described in the foregoing, the encryption of the service data 305 may have been carried out in the device 130 using a different service authentication key, e.g. the SDRK described in the foregoing. In this regard, the first device 110 may store, for one or more services, a respective predefined SDRK (applied for encryption of the service data 305 in the second device 130) and the decryption means may use the respective SDRK for decryption of the service data 305 received in the payload 300. If the encryption means applied in the second device 130 to encrypt the service data 305 has been initialized with the one or more initialization values prior to encrypting the service data 305, the decryption means in the first device 110 may use the same initialization values prior to decryption of the received service data 305. As described in the foregoing, the initialization values may comprise the unique identifier uval (or a predefined portion thereof) and/or the random or pseudo-random value nonce (or a predefined portion thereof).

One or more service identifiers 204 and/or one or more concealed service identifiers 304 may be transmitted from the second device 130 to the first device 110 in a message that also carries a device identifier (e.g. an address) assigned to the second device 130 and possibly also further information. Without losing generality, such a message is referred to in the following as a service information message. As an example, the second device 130 may transmit one or more service information messages that carry the payload 200 and/or the payload 300.

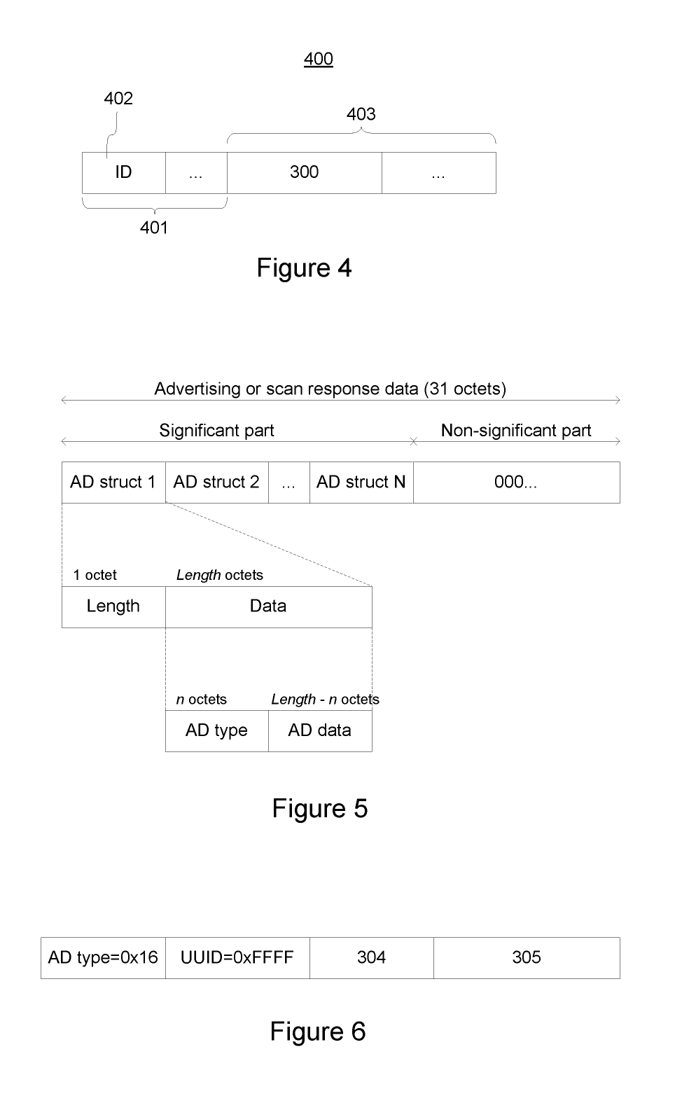

FIG. 4 schematically illustrates a conceptual example of a structure of a service information message 400 as outlined above. In this example the message 400 includes a message header 401 and message data 403. The message header 401 carries a device identifier 402 assigned for the second device 130, whereas the message data 403 carries the payload 300. Each of the message header 401 and the message data 403 may include also further information. In the example of FIG. 4 the message data 403 part includes a single payload 300. In other examples the message data 403 may include multiple (e.g. two or more) payloads 300, the message data 403 may include one or more payloads 200, or the message data 403 may include a combination of one or more payloads 200 and one or more payloads 300.

The device identifier 402 may comprise, for example, a public device identifier assigned for the second device 130, which may be applied as such by the first device 110 to identify and address the second device 130. In such a case usage of the service information message 400 to carry the payload 300 including the concealed service identifier 304 and/or service data 305 encrypted with an associated service authentication key (e.g. the SRK or the SDRK associated with the respective service) nevertheless enables limiting the availability of the service for intended recipients only, i.e. to those recipients that have the respective service identification key in their disposal.

As another example, the device identifier 402 may comprise an encrypted device identifier that is resolvable only by those receivers that have access to a device-specific device authentication key assigned for the second device 130. Typically, the devices paired/bonded with the second device 130 have the access to the device authentication key assigned therefor. Hence, making use of both the encrypted device identifier in a service information message 400 that carries the payload 300 including the concealed service identifier 304 and/or service data 305 encrypted with an associated service authentication key (e.g. the SRK or the SDRK associated with the respective service) enables providing and receiving the service without disclosing the identity of the second device 130 to a non-paired/non-bonded first device 110 that has access to the respective service identification key. On the hand, this also enables limiting the availability of the service for intended recipients among the devices that are paired/bonded with the second device 130, i.e. only to those devices that have the respective service identification key in their disposal.

In the following, as a non-limiting example, the device-specific device authentication key may be referred to as an identity resolving key (IRK). The encrypted device identifier may be generated using a mechanism similar to that described for the concealed service identifier in the foregoing. As an example, the second device 130 may construct the encrypted device identifier as a combination of a unique identifier uid computed using a predefined hash function hash_{d}( ) with a predefined device-specific device authentication key IRK and a random or pseudo-random component prand as its arguments, e.g. as

uid=hash_{d}(IRK,prand).

Herein, the has function hash_{d}( ) may be the same as the hash function hashₛ( ) or dedicated has function hash_{d}( ) that is different from the hash function hashₛ( ) may be applied.

The encrypted device identifier may be provided as a combination of two data fields (or data portions), first of which carries the unique identifier uid and second of which carries the random or pseudo-random component prand. Consequently, the device identifier 402 in the message header 401 of the device discovery message 400 may comprise a concatenation of the values of uid and prand as the device identifier assigned for the second device 130. Moreover, the device identifier 402 may comprise an indication of the type of device identification carried therein, e.g. to indicate whether the device identification is provided as a public device identifier, as an encrypted device identifier or a device identifier of some other type.

In case the device identifier 402 carries an encrypted device identifier, in order to enable recognizing the device identified by the encrypted device identifier received in the service information message 400 from the second device 130, the first device 110 needs to have access to the same predefined hash function applied in the second device 130 to generate the encrypted device identifier and it also needs to know the device authentication key assigned for the second device 130. In this regard, the first device 110 may store (e.g. in the memory 115) the hash function hash_{d}( ) and one or more device authentication keys. Consequently, upon reception of the service information message 400 including the values of the unique identifier uid and the random or pseudo-random component prand that constitute the encrypted device identifier, the first device 110 may determine whether any of the device authentication keys available therein is associated with the device identified by the encrypted device identifier.

The determination may involve the first device 110 testing the device authentication keys available therein one by one either until a matching device authentication key is encountered or until all available device authentication keys have been tested without encountering a matching device authentication key. The testing may involve computing the local unique identifier by

local_uidᵢ=hash_{d}(IRKᵢ,prand),

where hash_{d}( ) indicates the same predefined hash function applied in the second device 130 for computing the uid received as part of the encrypted device identifier (in the device identifier 402), where the parameter IRK indicates the device authentication key under testing, and where the parameter prand represents the random or pseudo-random component received as part of the encrypted device identifier (in the device identifier 402). The IRKᵢ is considered as a matching device authentication key in case the local_uidᵢ is equal to the uid received in as part of the encrypted device identifier.

While encountering the matching device authentication key IRKᵢ in the first device 110 serves as an identification of the second device 130 as a device that has been previously paired (and bonded) with the first device 110, the matching device authentication key IRKᵢ may be also applied for other purposes. As examples in this regard, the matching device authentication key IRKᵢ may be subsequently used by the first device 110 in an authentication procedure(s) with the second device 110, for encrypting data for transmission to the second device 130 and/or for decrypting data received from the second device 130.

To enable the generation of the concealed service identifier 304, the second device 130 may store (e.g. in the memory 135 and/or in a mass storage device available for the second device 130) the respective SRK for one or more services available in the second device 130. A SRK may be e.g. provided to the second device upon installing or configuring the service in the second device 130, e.g. upon installing/configuring a software application that is arranged to provide the respective service in the second device 130. As another example, a SRK may be generated by the second device 130 e.g. on basis of a predefined key generation procedure.

As described in the foregoing, the first device 110 may store a set of one or more service authentication keys for one or more services, where for each service the one or more service authentication keys include at least the SRK associated with a respective service and may comprise further service authentication keys (e.g. a respective SDRK) associated with the respective service. These services may be provided by the second device 130 and/or by one or more further devices. The first device 110 may obtain the service authentication key(s) in a number of ways. Two exemplifying scenarios in this regard are described in the following.

In one scenario, the first device 110 may receive the service authentication key(s) associated with a certain service available at the second device 130 from an entity different from the second device 130. Examples of such delivery means include receiving (e.g. downloading) the service authentication key(s) for the certain service from a server, receiving the service authentication key(s) for the certain service as user input (via the user interface of the first device 110) or obtaining the service authentication key(s) upon installing or configuring the first device 110 for receiving the certain service, e.g. upon installing/configuring a software application that is arranged to receive the certain service from the second device 130.

In this scenario the first device 110 that has the respective service authentication key(s) available therein is able to recognize the service identified by the concealed service identifier 304 received in the payload 300 transmitted from the second device 130 e.g. by using the procedure outlined in the foregoing, regardless of the type of the device identifier 402 applied in the service information message 400. Moreover, the first device 110 may further use the respective service authentication key to decrypt the service data 305 that may be encrypted by the second device 130 using the respective service authentication key e.g. by using the procedure outlined in the foregoing. Thus, the second device 130 is able to deliver the service to the first device 110 without disclosing its identity and the first device 110 may identify the service and receive service information pertaining to the service from the second device 130 without having or acquiring the knowledge regarding the identity of the second device 130. Nevertheless, the encrypted service data 305 may be applied to carry information that enables the first device 110 to establish pairing and/or bonding with the second device 130. The information that enables pairing and/or bonding may comprise e.g. a password, a pin code and/or indication of the identity of the second device 130. Consequently, in case the first device 110 has not yet established pairing and bonding with the second device 130, it may apply this received information to establish pairing and bonding with the second device 130 and/or establish a connection with the second device 130 without requiring user actions in this regard, thereby enabling subsequent automated secure connection establishment with the second device 130.

In another scenario, the first device 110 may receive the service authentication key(s) associated with a certain service available at the second device 130 from the second device 130 that is already paired and/or bonded with the first device 110. In this scenario, due to the pairing/bonding the secure connection between the devices 110, 130 may be established and the second device 130 may transmit (and the first device 110 may receive) respective service authentication key(s) for one or more services available in the second device 130 for subsequent use by the first device 110 over the secure connection. Consequently, the first device 110 may subsequently apply the received service authentication key(s) to recognize the respective service(s) identified by a concealed service identifier 304 received in the payload 300 transmitted from the second device 130 e.g. by using the procedure outlined in the foregoing and/or to decrypt the service data 305 received in the payload 300 e.g. by using the procedure outlined in the foregoing.

### Limited Availability of Services

In case there is a large number of SRKs stored in the first device 110, the service resolving procedure described in the foregoing may become a computationally intensive task. In this regard, the first device 110 may consider only a limited subset of the SRKs available therein in an attempt to recognize a service identified by the received concealed service identifier 304. The limited subset may be defined e.g. on basis of the current geographical location of the first device 110 (obtained e.g. from positioning means provided in the first device 110, such as a GPS receiver). As an example in this regard, one or more of the SRKs available in the first device may have a respective indication of a geographical position associated therewith and the first device 110 may consider these SRKs in the service resolving procedure only in case the current geographical position is close enough (e.g. closer than a predefined threshold distance) to the indicated geographical position. Along similar lines, one or more of the SRKs available in the first device 110 may have a timing indication associated therewith (indicating e.g. one or more times of the day and/or one or more days of the week) and the first device 110 may consider these SRKs in the service resolving procedure only in case the current time matches the indicated timing. Further along similar lines, one or more of the SRKs available in the first device 130 may have a user indication associated therewith (indicating e.g. one or more users for which the respective service is available) and the first device 110 may consider these SRKs in the service resolving procedure only in case the current user of the first device 110 is one of the indicated users.

### Further Security Measures

The first device 110 may further employ part of the information received in the payload 300 for authentication purposes after a (secure) wireless connection with the second device 130 has been set up. As an example in this regard, after having received the payload 300, recognized the service identified by the concealed service identifier 304, and established wireless connection with the second device 130, the first device 110 may submit an authorization value in one or more messages addressed to the second device 130. Consequently, upon receiving the authorization value the second device 130 verifies that a correct authorization value has been received and only authorizes the connection in response to successful verification of the authorization value. As an example, in context of the BLE communication the authorization value may be provided in a predefined characteristic or attribute of the generic attribute (GATT) profile.

As an example, the first device 110 may compute the authorization value aval using a predefined hash function hashₐ( ) with a predefined service-specific authorization key AK and a random or pseudo-random component arand as its arguments, e.g. as

aval=hashₐ(AK,arand).

Herein, the has function hashₐ( ) may be the same as the hash function hashₐ( ) or the hash function hash_{d}( ) or dedicated has function hashₐ( ) different from the hash functions hashₐ( ) and hash_{d}( ) may be applied. The authorization key (AK) may be, for example, the SRK or the SDRK associated with the respective service.

The random or pseudo-random component arand may comprise, for example, the unique identifier uval (or a predefined portion thereof) and/or the pseudo-random value nonce (or a predefined portion thereof) received in the payload 300 or a combination thereof. In the second device 130, the verification of the authorization value received from the first device 110 may comprise computing the local value of the authorization value aval and considering the verification successful if the locally computed value of the authorization value aval is equal to that received from the first device 110.

As a non-limiting example, the service discovery and service provision on basis of the concealed service identifier 304 described in the foregoing may be applied in context of the BLE communication. In such a case the employed wireless communication apparatuses in the wireless communication portions 112, 132 comprise respective Bluetooth transceivers arranged to operate according to the relevant BLE protocol(s) and to carry out the device discovery, the service discovery and possibly also the connection set-up and establishment according to the BLE specifications (as specified e.g. in the Bluetooth Specification).

In the BLE, the service information message 400 that carries the payload 300 may comprise a BLE advertising message transmitted from the second device 130 to enable the first device 110 both to detect the presence of the second device 130 and to identify the service(s) indicated in the service discovery message 400. The first device 110 may respond to the advertising message by a scan response message addressing the second device 130 to request a further service information message 400 to be transmitted. The second device 130 responds to the scan request message by transmitting a scan response message serving as the further service information message 400, which may also carry the payload 300. Hence, in the BLE example, the payload 300 may be carried in a BLE advertising message, in a BLE scan response message or in both. As particular examples, the payload 300 may be carried in its entirety in one of the BLE advertising message and the BLE scan response message, or the elements of the payload 300 may be divided between the BLE advertising message and the (subsequent) BLE scan response message e.g. such that the BLE advertising message carries the payload 300 including the payload header 301 and the concealed service identifier 304 (but not the service data 305) and the BLE scan response message carries the payload 300 including the payload header 301 and the service data 305 (but not the concealed service identifier 304).

FIG. 5 illustrates example structure for advertising data and scan response data applied in the BLE. The advertising or scan response data comprises a significant part and a non-significant part. The significant part carries the data and the non-significant part contains all-zero octets and its purpose is to extend the data if padding is needed to reach data size of 31 octets. Only the significant part needs to be sent over the radio link. The significant part comprises a sequence of advertising data (AD) structures (represented by AD struct 1, AD struct 2 and AD struct N in the example of FIG. 5). Each AD structure contains the length value L (one octet) followed by the data octets (L octets). The data octets include the AD type field (n octets, depending on the AD type) followed by the AD data octets (L−n octets). Advertising data according to the example of FIG. 5 may be carried in the AdvData field of an ADV_IND packet, of an ADV_NONCONN_IND packet or of an ADV_SCAN_IND packet. Scan response data according to the example of FIG. 5 may be carried in the ScanRspData filed of a SCAN_RSP packet. More detailed description of the advertising data and scan response data with the framework of BLE is provided e.g. in the Bluetooth Specification Volume 3, Part C, Section 11.

FIG. 6 illustrates an example mapping of the payload 300 into the data part of the AD structure. The AD type field (e.g. 1 octet) may be set into value 0x16 that indicates that it is followed by a16-bit UUID in the beginning of the AD data field. The UUID (e.g. 2 octets) is set to value 0xFFFF that indicates that is followed by service data, which in this example includes one or both of the concealed service identifier 304 (the fields uval and nonce described in context of FIG. 3, e.g. 3 octets each) and the service data 305 (e.g. 16 octets). The AD type field and the UUID of this example belong to the payload header 301, whereas the concealed service identifier 304 and/or the service data 305 in the AD data part belong to the payload data 303.

As another non-limiting example, the service discovery and service provision on basis of the concealed service identifier 304 described in the foregoing may be applied in context of the BLE communication. In such a case the employed wireless communication apparatuses in the wireless communication portions 112, 132 comprise respective WLAN transceivers arranged to operate according to the relevant WLAN protocol(s) and they me be arranged to carry out the device discovery and connection set-up according to the WLAN specifications (specified e.g. in IEEE 802.11 specifications), whereas the procedure and/or protocol applied for the service discovery and service provision procedure may be carried out according to any applicable standardized or proprietary protocol, such as Universal Plug and Play (UPnP) set of protocols or the Bonjour protocol known in the art. As a further example of an applicable service discovery protocol, the Service Location Protocol (SLP), specified e.g. in RFC 2608, may be applied.

In the WLAN example, the message 400 that carries the payload 300 may comprise a UDP packet (where the acronym UDP stands for the user datagram protocol specified e.g. in RFC 768) encapsulated in a IP packet (where the acronym IP stands for the internet protocol version 4 (IPv4) specified e.g. in RFC 791 or the internet protocol version 6 (IPv6) specified e.g. in to RFC 2460), where the payload 300 is included in the payload of the UDP packet. In the course of the service discovery discovery/provision procedure, the second device 130 may transmit and the first device 110 may receive one or more such UDP/IP packets as multicast packets according the respective version of the IP protocol (e.g. IPv4 or IPv6). The concealed service identifier 304 and the service data 305 may be transmitted in the same UPD/IP packet or they may be distributed into separate UDP/IP packets. The employed multicast address and the employed UDP port number may apply respective predefined values assigned for service discovery procedure.

Consequently, only the first devices 110 that are able to recognize the service identified by the concealed service descriptor 304 received in the UDP/IP multicast packet (e.g. according to the procedure described in the foregoing) are able to receive the respective service, e.g. the service information provided as encrypted service data 305, and/or to subsequently establish a wireless connection with the second device 130. Herein, the connection established between the first device 110 and the second device 130 may involve a unicast communication that employs TCP/UDP/IP packets (where the acronym TCP stands for the transmission control protocol specified e.g. in RFC 793).

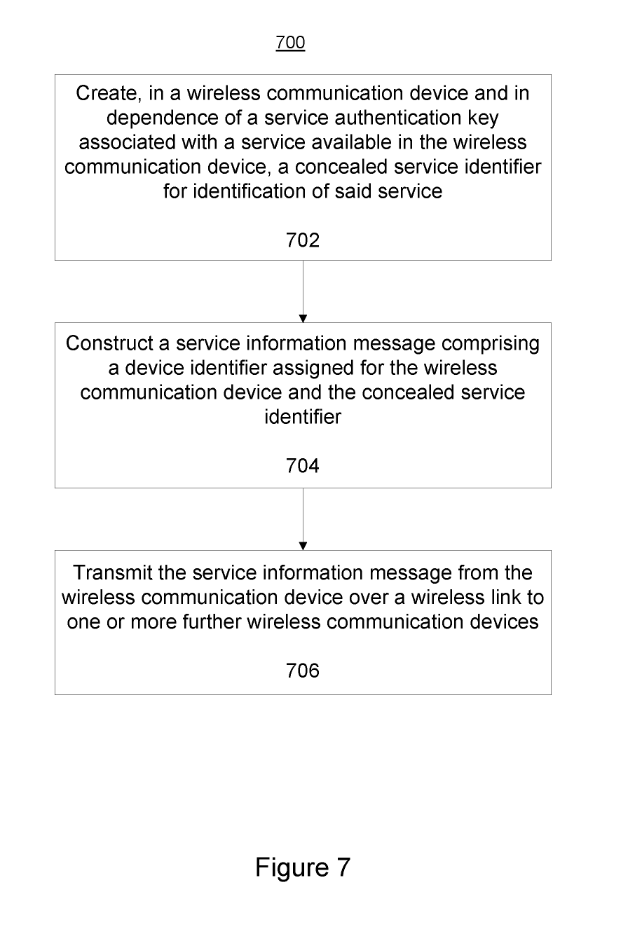

FIG. 7 outlines a method 700 according to an example embodiment of the invention. As a non-limiting example, the method 700 may be provided e.g. in the second device 130. The method 700 comprises creating, in a wireless communication device and in dependence of a service authentication key associated with a service available in the wireless communication device, a concealed service identifier for identification of said service, as indicated in block 702. As described in the foregoing, creation of the concealed service identifier may comprise computing a first unique identifier as a predefined hash function of the service authentication key and a first pseudo-random component and providing the concealed service identifier as a combination of said first unique identifier and said first pseudo-random component.

The method 700 further comprises constructing a service information message comprising a device identifier assigned for the wireless communication device and the concealed service identifier, as indicated in block 704. The method 700 further comprises transmitting the service information message from the wireless communication device over a wireless link to one or more further wireless communication devices, as indicated in block 706.

The method 700 may further comprise generating encrypted service information on basis of service information pertaining to said service using the service authentication key and transmitting the encrypted service information to one or more further wireless communication devices in one of the following: the service information message of block 704 and a subsequent service information message.

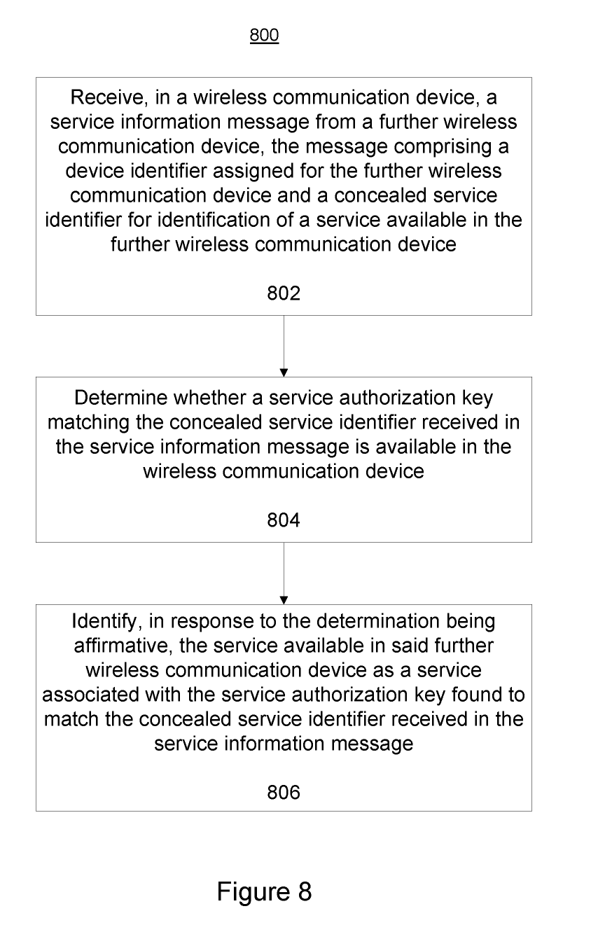

FIG. 8 outlines a method 800 according to an example embodiment of the invention. As a non-limiting example, the method 800 may be provided e.g. in the second device 110. The method 800 comprises receiving, in a wireless communication device, a service information message from a further wireless communication device, the message comprising a device identifier assigned for the further wireless communication device and a concealed service identifier for identification of a service available in the further wireless communication device, as indicated in block 802.

The method 800 further comprises determining whether a service authorization key matching the concealed service identifier received in the service information message is available in the wireless communication device, as indicated in block 804. The method 800 further comprises identifying, in response to the determination being affirmative, the service available in said further wireless communication device as a service associated with the service authorization key found to match the concealed service identifier received in the service information message, as indicated in block 806.

The methods 700 and/or 800 may be further varied in a number of ways, e.g. in accordance with the description of the operation between the first device 110 and the second device 130 provided in the foregoing.

Referring back to components of the first device 110 and the second device 130, the processor 116 is configured to read from and write to the memory 115 and the processor 136 is configured to read from and write to the memory 135. Although the processor 116, 136 is described as a single component, the processor 116, 136 may be implemented as one or more separate components. Similarly, although the memory 115, 135 is described as a single component, the memory 115, 135 may be implemented as one or more separate components, some or all of which may be integrated/removable and/or may provide permanent/semi-permanent/dynamic/cached storage.

The memory 115 may store the computer program 117 comprising computer-executable instructions that control the operation of the apparatus 110 when loaded into the processor 116. As an example, the computer program 117 may include one or more sequences of one or more instructions. The computer program 117 may be provided as a computer program code. The processor 116 is able to load and execute the computer program 117 by reading the one or more sequences of one or more instructions included therein from the memory 115. The one or more sequences of one or more instructions may be configured to, when executed by the processor 116, cause the apparatus 110 to carry out operations, procedures and/or functions described in the foregoing in context of the first device 110. Hence, the apparatus 110 may comprise at least one processor 116 and at least one memory 115 including computer program code for one or more programs, the at least one memory 115 and the computer program code configured to, with the at least one processor 116, cause the apparatus 110 to perform operations, procedures and/or functions described in the foregoing in context of the first device 110. Similar considerations are equally valid for the corresponding components 13x of the second device 130.

Each of the computer programs 117, 137 may be provided e.g. as a respective computer program product comprising at least one computer-readable non-transitory medium having program code stored thereon, the program code, when executed by the respective device or apparatus 110, 130, causes the apparatus at least to perform operations, procedures and/or functions described in the foregoing in context of the respective device 110, 130. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

1-39. (canceled)

40. A method comprising
creating, in a wireless communication device and in dependence of a service authentication key associated with a service available in the wireless communication device, a concealed service identifier for identification of said service,
constructing a service information message comprising a device identifier assigned for said wireless communication device and said concealed service identifier; and
transmitting said service information message from the wireless communication device over a wireless link to one or more further wireless communication devices.

41. The method according to claim 40, wherein said creating comprises
computing a first unique identifier as a predefined hash function of said service authentication key and a first random or pseudo-random component;
providing said first unique identifier in said concealed service identifier;
providing said concealed service identifier as a combination of said first unique identifier and said first random or pseudo-random component;
using said service authentication key, generating encrypted service information on basis of service information pertaining to said service; and
transmitting said encrypted service information to one or more further wireless communication devices in one of the following: said service information message and a subsequent service information message.

42. The method according to claim 40, wherein said service information message comprises one of the following:
an advertising packet in accordance with the Bluetooth Low Energy protocol, BLE,
a scan response packet in accordance with the BLE protocol, and
a user datagram protocol, UDP, packet encapsulated in an internet protocol, IP, packet.

43. A computer program product comprising at least one computer readable non-transitory medium having program code stored thereon, the program code configured to cause performing of the method of claim 40 when said program code is run on a computing apparatus.

44. A method comprising
receiving, in a wireless communication device, a service information message from a further wireless communication device, said message comprising a device identifier assigned for said further wireless communication device and a concealed service identifier for identification of a service available in said further wireless communication device;
determining whether a service authentication key matching the concealed service identifier received in said message is available in the wireless communication device; and
identifying, in response to said determination being affirmative, the service available in said further wireless communication device as a service associated with the service authentication key found to match said concealed service identifier.

45. An apparatus comprising at least one processor and at least one memory including computer program code for one or more programs, the at least one memory and the computer program code configured to, with the at least one processor, cause the apparatus at least to:
create, in dependence of a service authentication key associated with a service available in the apparatus, a concealed service identifier for identification of said service,
construct a service information message comprising a device identifier assigned for the apparatus and said concealed service identifier; and
transmit said service information message from said apparatus over a wireless link to one or more further wireless communication devices.

46. The apparatus according to claim 45, wherein said creating comprises:
computing a first unique identifier as a predefined hash function of said service authentication key and a first random or pseudo-random component;
providing said first unique identifier in said concealed service identifier; and
providing said concealed service identifier as a combination of said first unique identifier and said first random or pseudo-random component.

47. The apparatus according to claim 46, wherein said apparatus is caused to periodically change the value of said first random or pseudo-random component.

48. The apparatus according to claim 45, wherein the apparatus is further caused to:
generate, using said service authentication key, encrypted service information on basis of service information pertaining to said service; and
transmit, using said wireless communication portion, said encrypted service information to one or more further apparatuses in one of the following: said service information message and a subsequent service information message.

49. The apparatus according to claim 48, wherein said service information comprises information that enables establishing pairing with the apparatus.

50. The apparatus according to claim 45, wherein the apparatus is further caused to:
prior to transmitting said service discovery message, establish pairing with a further apparatus, comprising sharing a device authentication key assigned for the apparatus with said further apparatus; and
transmit said service authentication key to said further apparatus over a wireless communication link that is encrypted using said device authentication key.

51. The apparatus according to claim 45, wherein the apparatus is further caused to generate a random or pseudo-random address for use as said device identifier, said generating comprising:
computing a second unique identifier as a predefined hash function of a device authentication key assigned for said apparatus and a second random or pseudo-random component; and
providing said random or pseudo-random address as a combination of said second unique identifier and said second random or pseudo-random component.

52. The apparatus according to claim 45, wherein said service information message comprises one of the following:
an advertising packet in accordance with the Bluetooth Low Energy protocol, BLE,
a scan response packet in accordance with the BLE protocol, and
a user datagram protocol, UDP, packet encapsulated in an internet protocol, IP, packet.

53. An apparatus comprising at least one processor and at least one memory including computer program code for one or more programs, the at least one memory and the computer program code configured to, with the at least one processor, cause the apparatus at least to
receive, over a wireless communication link, a service information message from a further apparatus, said message comprising a device identifier assigned for said further apparatus and a concealed service identifier for identification of a service available in said further apparatus;
determine whether a service authentication key matching the concealed service identifier received in said message is available in the apparatus; and
identify, in response to said determination being affirmative, the service available in said further apparatus as a service associated with the service authentication key found to match said concealed service identifier.

54. The apparatus according to claim 53, wherein said concealed service identifier comprises a first unique identifier, computed in said further apparatus as a predefined hash function of said service authentication key and a first random or pseudo-random component; and said concealed service identifier further comprises said first random or pseudo-random component.

55. The apparatus according to claim 54, wherein said determination comprises
compute a second unique identifier as said predefined hash function of a service authentication key under consideration and said first pseudo-random component; and
determine the service authentication key under consideration to match the concealed service identifier received in said message in response to the second unique identifier being equal to said first unique identifier.

56. The apparatus according to claim 53, wherein the apparatus is further caused to:
receive, from said further apparatus, encrypted service information; and
decrypt using said service authentication key found to match said concealed service identifier, decrypt the received encrypted service information to obtain service information pertaining to said service.

57. The apparatus according to claim 56,
wherein decrypted service information comprises information that enables establishing pairing with said further apparatus; and
wherein the apparatus is further arranged to establish pairing with the further apparatus by using said decrypted service information.

58. The apparatus according to claim 53, wherein the apparatus is further caused to:
prior to receiving said service discovery message, establish pairing with said further apparatus, comprising receiving a device authentication key assigned for said further apparatus; and
receive said service authentication key from said further apparatus over a wireless communication link encrypted using said device authentication key.

59. The apparatus according to claim 53, wherein said service information message comprises one of the following:
an advertising packet in accordance with the Bluetooth Low Energy protocol, BLE,
a scan response packet in accordance with the BLE protocol, and
a user datagram protocol, UDP, packet encapsulated in an internet protocol, IP, packet.
